(19) United States
(12) Patent Application Publication
(10) Pub. No.: US 2010/0225268 A1
(43) Pub. Date: Sep. 9, 2010

(54) ARTICLE OF MANUFACTURE HAVING A REMOVABLE SOLAR RECHARGEABLE POWER SUPPLY

(76) Inventor: Shun Kit Hui, Hong Kong (CN)

Correspondence Address: LACKENBACH SIEGEL, LLP, LACKENBACH SIEGEL BUILDING, 1 CHASE ROAD, SCARSDALE, NY, 10583, US

(21) Appl. No.: 12/682,972

(22) PCT Filed: Jan. 6, 2009
(86) PCT No.: PCT/US2009/030215

§ 371 Date: May 10, 2010

Related U.S. Application Data
(60) Provisional application No. 61/019,579, filed on Jan. 7, 2008.

(30) Foreign Application Priority Data
Mar. 10, 2008 (CN) ZL200820007245.7

(51) Int. Cl. H01M 10/46; H02J 7/00

(52) U.S. Cl. 320/101; 307/150

(57) ABSTRACT

The invention is an electronic device having a removable solar rechargeable power supply. A power supply module and battery pack are removable from the base unit as a sub-unit, or as a kit. The power supply contains batteries that are replaceable and rechargeable. Additionally, the power supply contains a solar cell secured to the power supply and integrated such that the solar cell, when receiving radiation, generates a voltage managed by the circuit to recharge the batteries until a completion level is reached, whereupon the recharging circuit reacts to prevent overcharging and damage to either the circuit or the batteries. An optional feature includes a circuit linking feature to electronically couple to the power supply circuit of the device such that the batteries supply power to the main unit during normal use until the batteries are drained and then the solar cell provides operative power to the main unit.

### CROSS REFERENCE TO RELATED APPLICATIONS

This application relates to and claims priority from U.S. Ser. No. 61/019579 filed Jan. 7, 2008 and Chinese Utility Model Patent Ser. No. ZL200820007245.7 filed Mar. 10, 2008, the entire contents of each of which are incorporated herein fully by reference.

### BACKGROUND OF THE INVENTION

1. Field of the Invention

The present invention relates to an article of manufacture having a removable solar rechargeable power supply unit. More specifically, the present invention relates to an article of manufacture (e.g., an electronic educational device; a game handset; a calculator; a radio; etc.) wherein the removable battery power supply unit is separately rechargeable via a solar cell feature in operative combination with rechargeable batteries (power cells), optionally includes non-rechargeable batteries in a parallel circuit, and enables operational power supply by either a rechargeable or non-rechargeable battery power supply. As an alternative embodiment, the article of manufacture may additionally operate via power supplied directly from the solar cell when power has been drained from both the rechargeable and non-rechargeable batteries.

2. Description of the Related Art

The related art involves conventionally known solar power supply cells permanently fixed (irremovable) to an electronic article of manufacture such as a calculator, a hand watch, or a music player. These types of conventional solar cells are conventionally constructed from crystalline silicone wafers but may also be constructed from the more recently-developed non-crystalline/amorphous silicon cells. A recognized detriment to such strictly solar-cell based power supplies is the limited DC (Direct Current) voltage they can generate relative to a surface area exposed to radiation. While the volume of this DC voltage can be increased by increasing surface area of the solar cell, this is cumbersome when dealing with consumer product devices where small size is highly desirable. Therefore, while the efficiency of solar cells is recognized as generally increasing with technological gains, such solar cells have yet to be effective competitors in the rapid power supply market presently populated by chemical batteries.

The related art also involves conventionally known removable power supply units, such as the removable battery packs known in the powered hand-tool industry (electronic drills). These types of devices demand rapid high-power output from their power supplies to effectuate the high motor torque required in the construction trades. This type of high torque could not be effectively generated by a solar cell shaped to fit on a hand tool and thus chemical batteries (typically rechargeable or optionally non-rechargeable) have been employed.

Where this type of hand tool employs a rechargeable chemical battery pack (often the units are sold in pairs with the tool in combination with a recharging unit), when the power is depleted from a particular battery pack, the packs are swapped out and the drained one is installed in the recharging unit connected to a household AC current supply for recharging. In this manner, via swapping of rechargeable battery packs, continual use of the powered hand-tool is achievable but at the cost of being continually tied to the conventional AC (Alternating Current) power supply grid and a separate recharging unit that may be lost and damaged.

What is not appreciated by the related art is the benefit of eliminating the need for a recharging unit apart from the battery pack or power supply itself. To date, this has been contrary to conventional wisdom.

What is further not appreciated by the related art is the benefit of providing a removable solar rechargeable power supply in an article of manufacture intended for the educational market, or any other consumer market, where rapid article-movement is desired separate from the conventional recharging AC current supply grid. Additionally, the removable solar power supply can be constructed so as to be in kit form for use with varied host devices configured to receive the kit for the supply of power.

Accordingly, there is a need for an article of manufacture operating with a power supply system involving a removable solar rechargeable power pack.

### ASPECTS AND SUMMARY OF THE INVENTION

An aspect of the present invention is to provide an article of manufacture having a power supply system involving a removable solar rechargeable battery pack.

Another aspect of the present invention is to provide a power supply system for an electronic consumer device wherein the power supply is a removable battery pack and is rechargeable in situ (in process) as a monolith without a separate rechargeable pack.

Another aspect of the present invention provides a removable battery-based power supply containing both rechargeable and non-rechargeable batteries.

Another aspect of the present invention provides a recharging system built-into a monolithic, removable, battery based power supply which enables recharging without connection to an external power grid source.

Another aspect of the present invention is to provide a recharging system built-into a monolithic, removable, battery power supply containing both rechargeable and non-rechargeable batteries connected in a parallel circuit with a solar cell panel, wherein a switching mode component is provided enabling a switch in power supply between the rechargeable batteries and the non-rechargeable batteries.

Another aspect of the present invention provides a recharging system built-into a monolithic, removable, battery power supply containing both rechargeable and non-rechargeable batteries connected in a parallel circuit with a solar cell panel, wherein a switching mode component is provided enabling a switch in power supply between the rechargeable batteries and the non-rechargeable batteries, and wherein the switching mode component and recharging circuit prohibits over-charging and damage to the rechargeable batteries.

Another aspect of the present invention is to provide a self-contained kit that is capable of powering varied host devices configured to receive the kit for the supply of power. This aspect allows the manufacture of a host device in modular configurations, capable of being linked to the power kit; and, further allows a single configuration to be used across multiple platforms.

The present invention relates to an article of manufacture having a removable solar rechargeable power supply. A power supply, alternatively called a battery pack module, or simply a battery pack, herein without restriction, is removable from the main unit in a way that removes both the batteries and solar cell as a single unit from the operational power supply circuit of the article of manufacture (e.g., a children's toy or other product).

The power supply contains one or more individual batteries that are (i) optionally replaceable and (ii) rechargeable (for example, standard AA rechargeable batteries). The power supply also contains a solar cell member having a protective transparent window that is secured in a removable or non-removable way to the power supply and integrated with a circuit flow such that the solar cell, when receiving radiation, generates a voltage managed by the circuit to recharge the rechargeable batteries until a completion level is reached whereupon the recharging circuit de-couples/breaks/controls itself to prevent overcharging and damage to either the circuit or the rechargeable batteries or other elements in the operative power supply circuit.

Another optional feature of the present invention enables the power supply when reinstalled in the article of manufacture (or educational toy) to include a circuit linking feature to electronically couple or link to the power supply circuit of the device such that (optionally either) the regular batteries or the rechargeable batteries or both supply power to the toy during normal use until they are drained according to an internal switching mode determination and then the solar cell provides operative power to the article of manufacture.

Another optional feature of the present invention enables an internal switching mode, when the power supply unit is installed, to recognize variable power draw requirements from the article of manufacture and remaining power supplies within the rechargeable and non-rechargeable batteries and to allow such switching to occur automatically as is necessary to maintain a predetermined acceptable power supply level for effective article operation.

Another optional feature of the present invention enables a computer control of both an internal switching mode controller (not shown) and optionally a switching module that enables effective operative action of the proposed removable solar rechargeable power supply.

According to an alternative embodiment of the present invention, there is provided a removable solar rechargeable power supply for an electronic device, the power supply supplying an operative power to the electronic device, and comprising: a power supply container for containing the rechargeable power supply, the power supply container being removably engageable with the electronic device between uses; an electronic power supply and recharging circuit in the power supply container, comprising a solar panel member in series with a diode member, and the solar panel member and diode member in parallel with a rechargeable battery unit, whereby the solar panel member provides a charging energy to the rechargeable battery unit at least once during, or between, uses.

According to another alternative embodiment of the present invention, there is provided a removable solar rechargeable power supply for an electronic device, further comprising: a non-rechargeable battery unit in the electronic power supply and recharging circuit; a switching component operatively switching between the rechargeable battery unit and the non-rechargeable battery unit; and, the non-rechargeable battery unit in the circuit in parallel with the rechargeable battery unit, whereby during use, the switching component operatively switches between each respective power source of the unit to supply the operative power to the electronic device.

According to another alternative embodiment of the present invention, there is provided a removable solar rechargeable power supply for an electronic device, wherein the switching component includes electronic control means for determining an optimal period for switching between each respective power source of the unit to supply the operative power to the electronic device according to electronic control parameters. The electronic control parameters include at least one of the following parameters: a current supply parameter; a voltage supply parameter; a power draw parameter from the electronic device; an estimated charge remaining in the rechargeable battery unit parameter; and, an estimated charge remaining in the non-rechargeable battery unit parameter.

According to another alternative embodiment of the present invention, there is provided an electronic device having a removable solar rechargeable power supply, comprising: an operative circuit in the electronic device; a power supply container for containing the removable rechargeable power supply, the power supply container being separable from the electronic device between uses and removably engageable with the operative circuit in the electronic device during a use thereof; an electronic power supply and recharging circuit in the power supply container, comprising: a solar panel member in series with a diode member, the solar panel member and diode member in parallel with a rechargeable battery unit, whereby the solar panel member provides a charging energy to the rechargeable battery unit; and, a non-rechargeable battery unit in the electronic power supply and recharging circuit.

According to another alternative embodiment of the present invention, there is provided an electronic device having a removable solar rechargeable power supply, further comprising: a switching component in the electronic power supply and recharging circuit; the switching component operatively switching between the rechargeable battery unit and the non-rechargeable battery unit to supply power to the operative circuit during use.

According to another alternative embodiment of the present invention, there is provided an electronic device having a removable solar rechargeable power supply, wherein the non-rechargeable battery unit is in the circuit in parallel with the rechargeable battery unit; and, whereby, during use the switching component operative switches between each respective power source of the unit to supply the operative power to the electronic device.

The above, and other aspects, features and advantages of the present invention, will become apparent from the following description read in conjunction with the accompanying drawings, in which like reference numerals designate the same elements.

### BRIEF DESCRIPTION OF THE DRAWINGS

FIG. 1 is a perspective top view of one alternative embodiment of an article of manufacture having a removable solar rechargeable power supply, shown here as a closed solar laptop educational device for children with the power supply and solar panel in place.

FIG. 2 is a perspective top view of FIG. 1 with the removal of the solar panel with battery pack for solar recharging apart from the device.

FIG. 3A is a perspective exploded view of the solar rechargeable battery pack of FIGS. 1 and 2.

FIG. 3B is a perspective view of the recharging step of solar-recharging of the rechargeable power supply.

FIG. 4 is a perspective image of an article of manufacture as introduced in FIG. 1 as a solar laptop educational device for children, noting the ready integration of the present invention.

FIG. 5 is a second perspective image of an alternative article of manufacture as introduced earlier, shown as a solar electronic book-type educational device for children.

FIG. 6 is a third perspective image of another alternative article of manufacture as introduced earlier, shown as an electronic hand-strap supported keyboard-type alphabet educational device for children.

FIG. 7A is an exemplary circuit diagram of an alternative article of manufacture employing a removable and solar rechargeable power supply enabling the article of manufacture to receive operative power from a normal battery and a rechargeable battery via a switch-mode controller (noted at K2), here for a solar piano device.

FIG. 7B is an alternative exemplary circuit diagram of a second alternative article of manufacture employing a removable and solar rechargeable power supply enabling the article of manufacture to receive operative power from both a normal battery and a rechargeable battery via a switch-mode controller (noted at K2), here for a solar toy device.

FIG. 7C is an alternative exemplary circuit diagram of a third alternative article of manufacture employing a removable and solar rechargeable power supply enabling the article of manufacture to receive operative power from both a normal battery and a rechargeable battery via a switch-mode controller (noted at K2), here for an alternative solar toy device.

FIG. 7D is an alternative exemplary circuit diagram of a fourth alternative article of manufacture employing a removable and solar rechargeable power supply enabling the article of manufacture to receive operative power from both a normal battery and a rechargeable battery via a switch-mode controller (noted at K2), here for a third alternative solar toy device.

FIG. 7E is an alternative exemplary circuit diagram of a fifth alternative article of manufacture employing a removable and solar rechargeable power supply enabling the article of manufacture to receive operative power from both a normal battery and a rechargeable battery via a switch-mode controller (noted at K2), here for a fourth alternative solar toy device.

FIG. 8 is a schematic figure diagram representing an alternative embodiment of the present invention, wherein a computer processor conducts a control and monitoring process between multiple circuit factors enabling optimum circuit operation.

### DETAILED DESCRIPTION OF THE PREFERRED EMBODIMENTS

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, and below may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices.

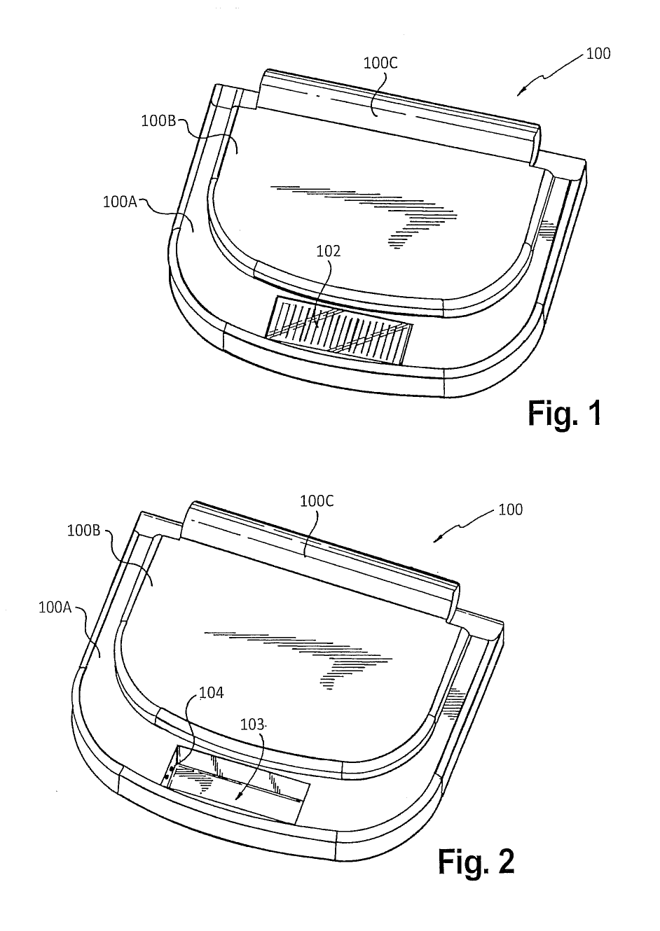

Referring now to FIGS. 1 through 3B, an article of manufacture or device 100, noted here as a solar educational laptop for kids (but, which can be any suitable host electronic device), includes a solar cell or panel 102 on a removable power supply or battery pack 101, stored in a power supply or battery pack bay 103 during operative use. It will be recognized by those of skill in the electronic consumer arts, that device 100 may be any optional readily transportable consumer device without departing from the scope and spirit of the present invention.

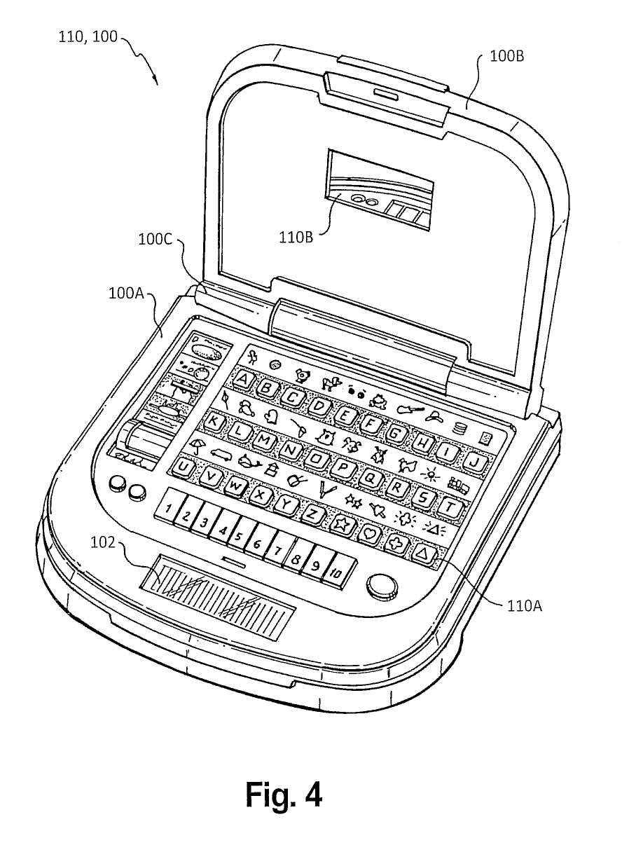

Here, device 100, shown as a laptop, includes a main bottom case member 100A and a main display screen member 100B pivotally attached via an operative pivot hinge member 100C, such that during use pivot hinge member 100C rotates allowing internal access to display screen member 100B and the input keys (not shown) positioned on main bottom case member 100A (See also FIG. 4).

As noted herein, an electronic connection interface or electronic contact members 104 are positioned within battery pack bay 103 so that upon installation of battery pack 100, corresponding contacts 104A operatively engage contact members 104 and complete a power supply circuit as will be discussed further.

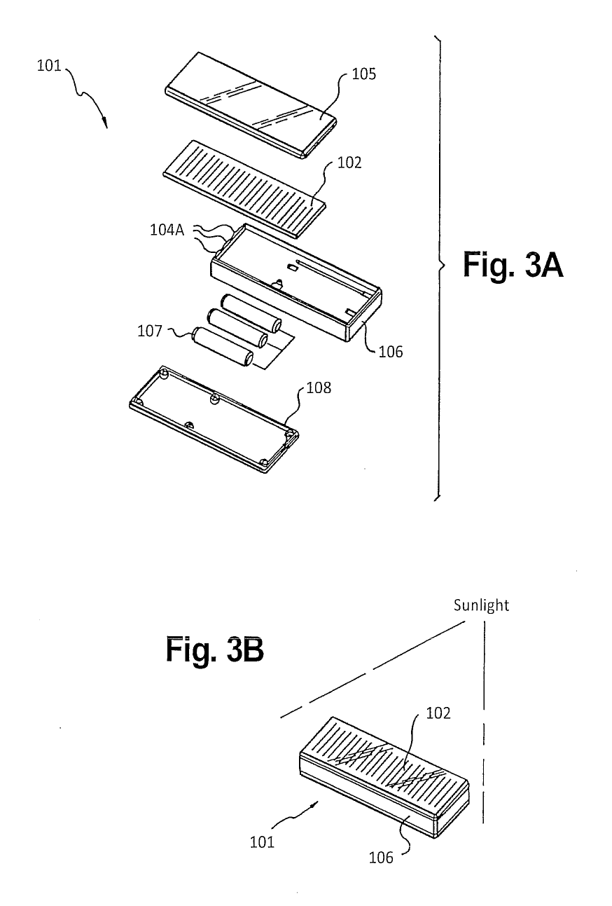

Referring specifically to FIGS. 3A and 3B, power supply or battery pack 101 additionally includes securing means or engagement clips (both not shown) to secure same within bay 103 during use to prohibit unintended removal of the same. Those of skill in the art will recognize that such securing means or engagement clips may be readily adapted from related means or features in the conventional arts without departing from the scope and spirit of the present invention. As noted, power supply or battery pack 101 includes a solar cell protective clear shield 105 covering solar cell or panel 102 secured to a top portion of a battery pack case 106 that additionally contains one or more chemical batteries 107, secured by a bottom lid 108.

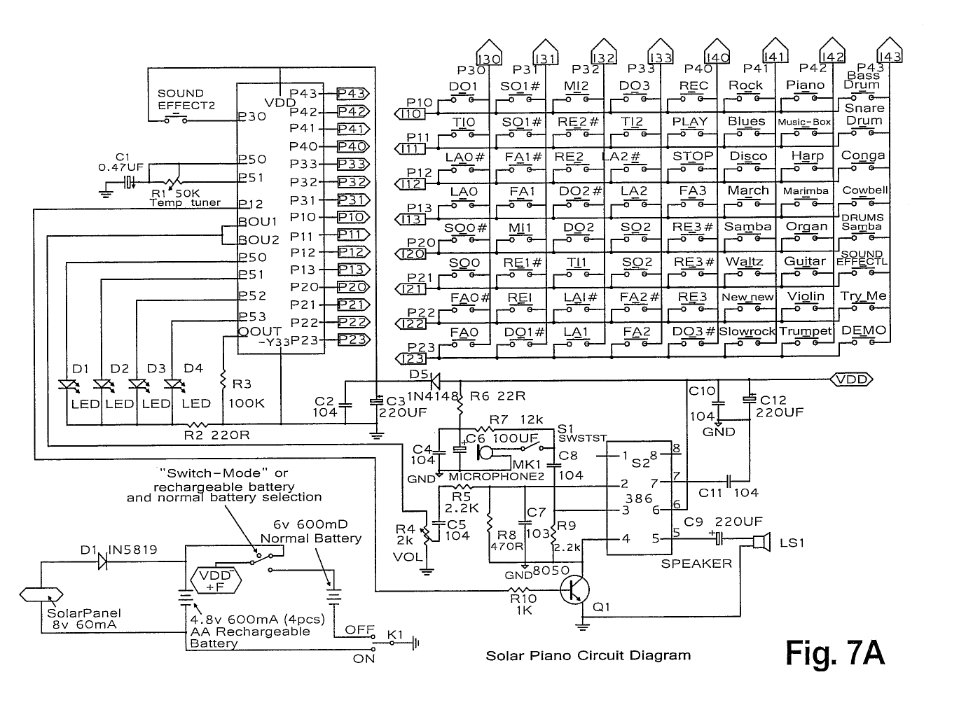

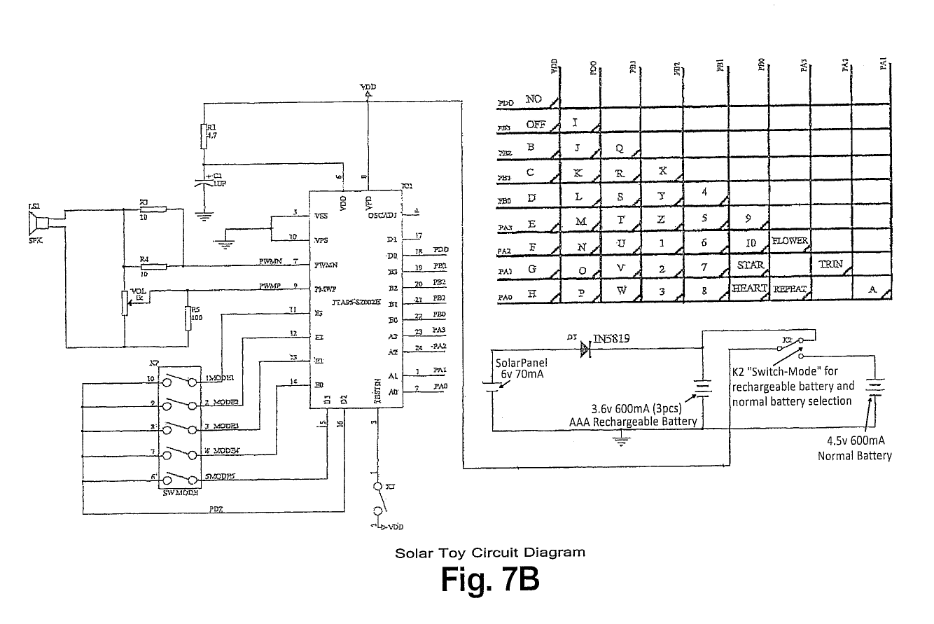

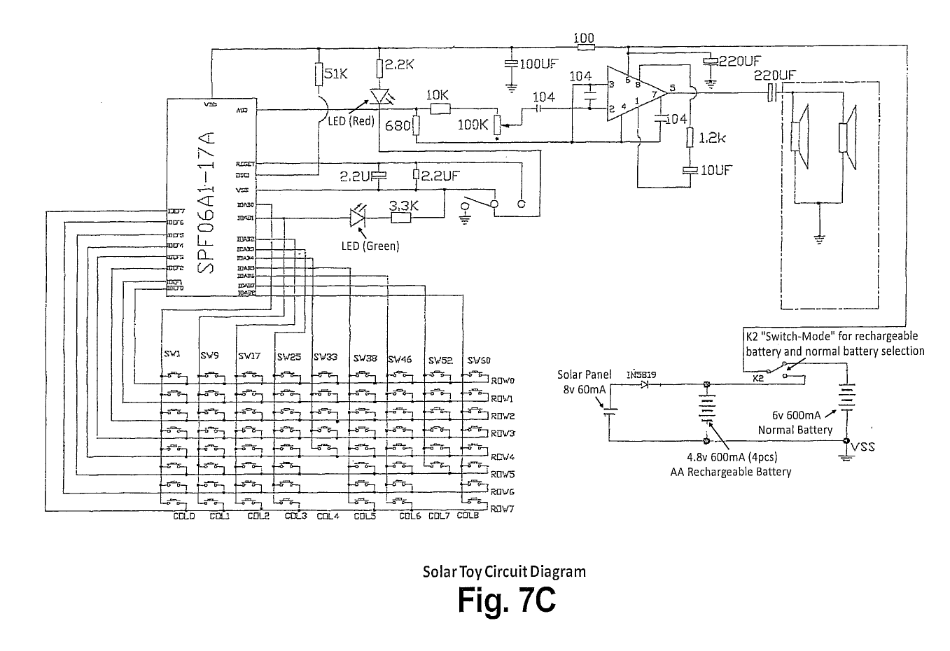

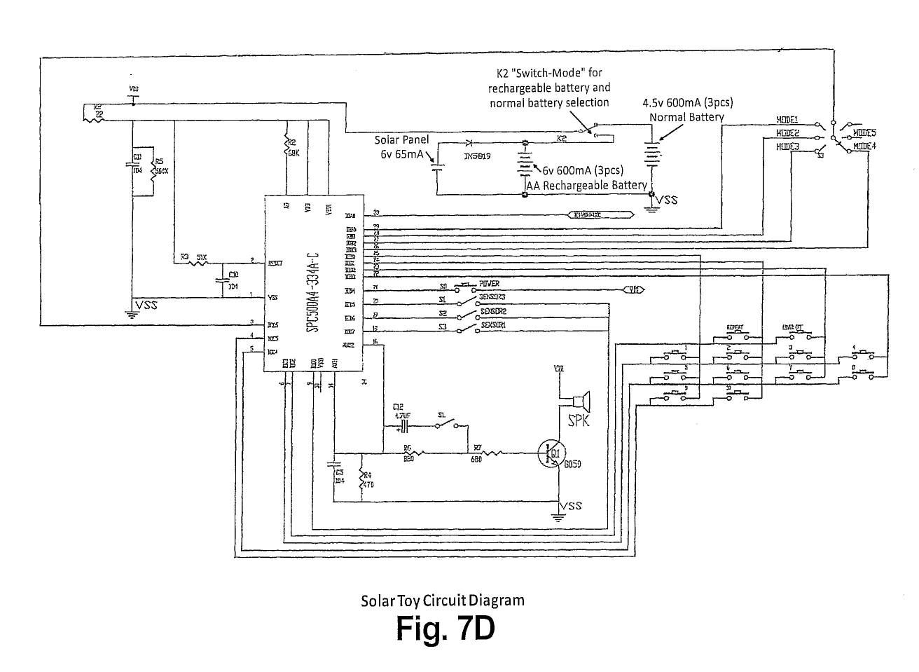

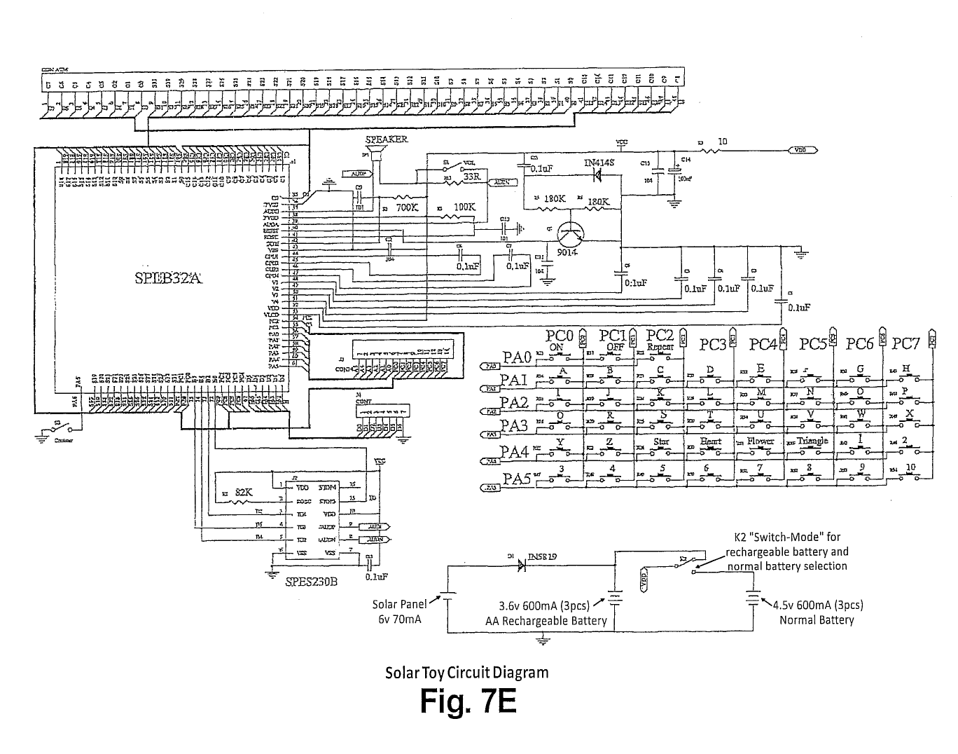

It will be recognized that batteries 107 are preferably rechargeable, for example 4.8V 600 mA AA rechargeable batteries, although any other form of rechargeable power supply may be substituted without departing from the scope and spirit of the present invention. It will be additionally recognized that batteries 107 may also include in a parallel circuit one or more non-rechargeable batteries, for example 6V 600 mA AA normal batteries. Solar panel or solar cell member 102 may be of any suitable construction (crystalline or non-crystalline) but as shown herein is an 8v 60 mA solar panel. Those of skill in the art will recognize that contained within removable and rechargeable power supply 101 are one or more control circuits and either switching circuits or control modules (not shown here, but shown later as K2 switch mode in FIGS. 7A-7E), that may be employed to regulate the power, supplied via contacts 104, 104A during use, and the recharging rate during the removed recharging mode. It will be additionally recognized by those of skill in the art that solar recharging of the rechargeable power supply 101 may adaptively occur during installation in the apparatus or device 100 such that those of skill in the art will understand continual charging occurs as optimized for the performance of device 100. In this way, those of skill in the art will recognize operationally, that when device 100 is not in use, recharging of battery pack 101 can occur without risk to device 100 when the pack is installed and optionally when it is not installed, to provide maximum adaptation for user-convenience.

Referring now to FIG. 4, one alternative embodiment 110 is depicted as a solar powered laptop for children wherein the top lid is in an open position revealing a plurality of play-entry keys 110A and a display device 110B for educational learning. This alternative embodiment 110 is to be recognized as non-limiting and is exemplary of the particular inventive concepts and details discussed herein.

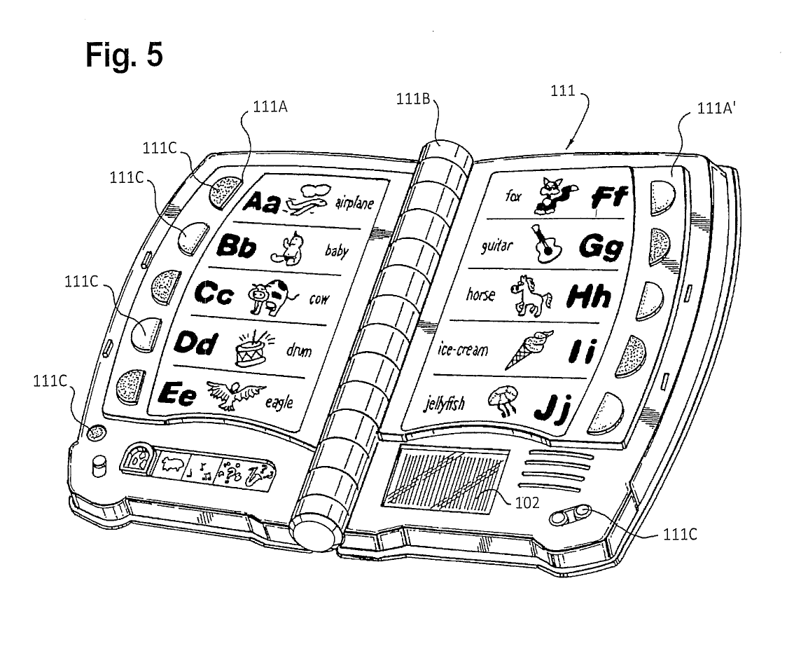

For example, in an alternative adaptive embodiment, consumer rechargeable device 111 (FIG. 5) is noted as a book-format wherein a plurality of page members 111A, 111A′ are pivotable relative to a central hinge member 111B. The pivoting adaptability of page members 111A, 111A′ allows for a number of operative switches and educational inputs, respectively noted at 111C, without departing from the scope and spirit of the present invention.

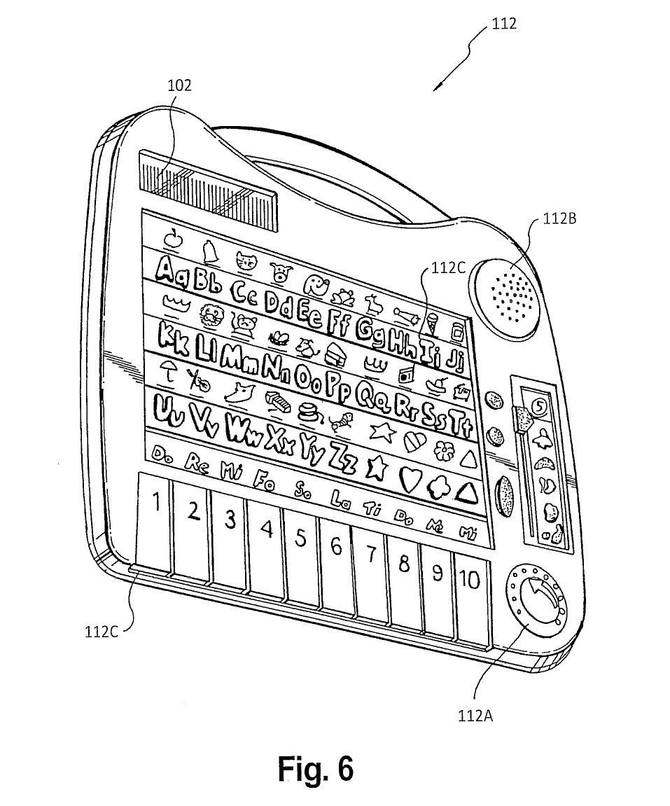

Referring now to FIG. 6, wherein an additional adaptive embodiment of a consumer rechargeable device 112 is presented, this time as a type of electronic hand-strap supported keyboard-type alphabet educational device for children. There are a number of key inputs 112C, a speaker device 112B, and a dial switch 112A allowing an enhanced educational experience.

As will be noted by those of skill in the art when considering alternative embodiments noted at FIGS. 4, 5, and 6, solar cell or solar panels 102 for each replaceable power pack 110 are visibly presented in the device. As will be recognized by those of skill in the art of designing consumer electronic devices, a plurality of housing mechanisms and housing arrangements, each removable, may be constructed for such electronic devices without departing from the scope and spirit of the present invention.

Referring now to FIGS. 7A through 7E, a plurality of exemplary circuit schematics are presented representative of alternative aspects and embodiments of the present invention. In FIG. 7A (noted as a Solar Piano embodiment), a solar panel (8V 60 mA) is presented to absorb solar radiation, converting the same to electricity directly; and, via diode IN5819, the electricity will be transferred to a rechargeable battery element (4.8V 600 mA AA rechargeable battery). A switching module K2 optionally engages the rechargeable circuit/solar panel, or a non-rechargeable battery (6V 600 mA AA battery), via a switching module K1 so that effectively 600 mA are supplied to the embodiment upon operative engagement of either the rechargeable batteries or the non-rechargeable batteries. The additional features in the circuit diagram of FIG. 7A will be recognized by those of skill in the electronic arts as particular to the requirements of the particular embodiment. In a related manner, alternative circuit diagrams and slight configuration variants are presented in FIGS. 7B through 7E. It will be recognized by those of skill in the art, that each of the respective circuit configurations in FIGS. 7A thorough 7E represent differing consumer products; but, that the power supply circuits are clearly representative of the functions and removable operative rechargeable modes noted and discussed above, and that each will be recognized as being a fully operative description of the particular alternative embodiment. It is noted that hand-identifiers are presented in the circuit for clarification of the specific electronic symbols that are readily understood by those of skill in the electronic design arts. As a consequence, the comprehensive exemplary disclosures noted in FIGS. 7A through 7E will be recognized as sufficiently specific to enable those of skill in the art to construct a representative removable and solar rechargeable power supply without undue experimentation such that the device may be operated by non-rechargeable or rechargeable power supplies based upon the switching modes and switching controller operations.

It will be additionally recognized, by those of skill in the art, that computer control modules may be connected in the rechargeable circuit enabling a monitoring of device-use power draw and power supply levels allowing a switching at a predetermined level, while also monitoring recharging functions to prevent unit and circuit damage.

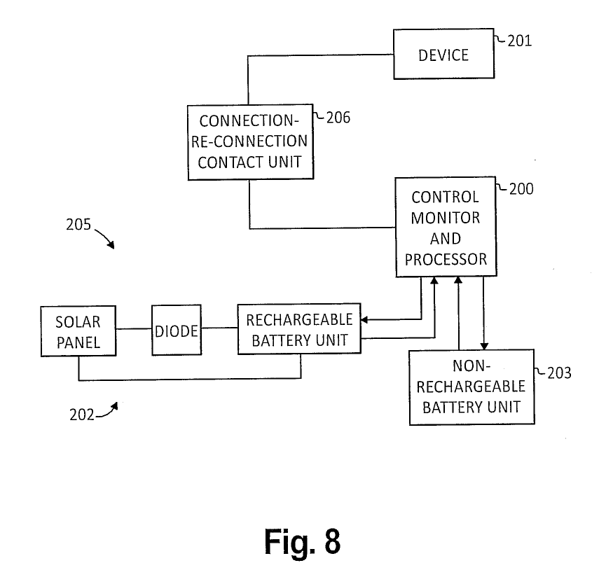

Referring now to FIG. 8, an alternative embodiment of the present invention is provided wherein a computer processor module 200 operatively controls current and power flow between device 201 and respective rechargeable battery unit circuit 202 and non-rechargeable battery unit 203 in a control circuit 205 electronically connectable to device 201 via a connection and re-connection contact unit 206 which functions to ensure electronic connection between the removable solar rechargeable power supply (containing processor module 200, and battery units 202, 203) and device 201.

As noted above, those of skill in the art will readily appreciate having studied the present disclosure that computer processor module 200 may be equipped with a plurality of current flow and monitoring features (not shown) allowing computer processor module 200 to monitor circuit features, including but not limited to total and average power draw from device 201 during use and between rechargeable unit-swaps, available current or power in respective battery units 202, 203, rate of current draw at current time, a rolling projected current draw, recharging rate for unit 202 to minimize risk of over-charge damage, emergency use of solar panel supply via rechargeable battery unit when both rechargeable battery unit 202 and 203 are fully depleted so as to provide a degree of power to device 201, and other features as will be recognized by those of skill in the computer circuit monitoring arts.

In the claims, means or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Having described at least one of the preferred embodiments of the present invention with reference to the accompanying drawings, it is to be understood that the invention is not limited to those precise embodiments, and that various changes, modifications, and adaptations may be effected therein by one skilled in the art without departing from the scope or spirit of the invention as defined in the appended claims.

What is claimed is:

1. A removable solar rechargeable power supply for an electronic device, said power supply supplying an operative power to said electronic device, and comprising:
(a) a power supply container for containing said rechargeable power supply, said power supply container being removably engageable with said electronic device between uses; and
(b) an electronic power supply and recharging circuit in said power supply container, further comprising a solar panel member in series with a diode member; and, wherein said solar panel member and said diode member are in parallel with a rechargeable battery unit, whereby said solar panel member provides a charging energy to said rechargeable battery unit at least once during or between said uses.

2. A removable solar rechargeable power supply for an electronic device, according to claim 1, further comprising:
(a) a non-rechargeable battery unit in said electronic power supply and recharging circuit; and
(b) a switching component operatively switching between said rechargeable battery unit and said non-rechargeable battery unit; and, wherein said non-rechargeable battery unit in said circuit is in parallel with said rechargeable battery unit, whereby during said use said switching component operatively switches between each of said rechargeable and said non-rechargeable battery units to supply said operative power to said electronic device.

3. A removable solar rechargeable power supply for an electronic device, according to claim 2, wherein:
(a) said switching component includes electronic control means for determining when to switch between each respective said unit to supply said operative power to said electronic device according to electronic control parameters, and
(b) said electronic control parameters including at least one of the following parameters; a current supply parameter, a voltage supply parameter, power draw parameter from said electronic device, an estimated charge remaining in the rechargeable battery unit parameter, and an estimated charge remaining in the non-rechargeable battery unit parameter.

4. An electronic device having a removable solar rechargeable power supply, comprising:
(a) an operative circuit in said electronic device;
(b) a power supply container for containing said removable rechargeable power supply; and, wherein said power supply container is capable of being separable from said electronic device between uses and removably engageable with said operative circuit in said electronic device during a use thereof; and
(c) an electronic power supply and recharging circuit in said power supply container further comprising:
(i) a solar panel member in series with a diode member; and, wherein said solar panel member and diode member are in parallel with a rechargeable battery unit, whereby said solar panel member provides a charging energy to said rechargeable battery unit; and
(ii) a non-rechargeable battery unit in said electronic power supply and recharging circuit.

5. An electronic device having a removable solar rechargeable power supply, according to claim 4, further comprising:
a switching component in said an electronic power supply and recharging circuit; and, wherein said switching component operatively switches between said rechargeable battery unit and said non-rechargeable battery unit to supply power to said operative circuit during said use.

6. An electronic device having a removable solar rechargeable power supply, according to claim 5, wherein:
said non-rechargeable battery unit is in said circuit in parallel with said rechargeable battery unit, whereby during said use said switching component operatively switches between each of said rechargeable and said non-rechargeable battery units to supply said operative power to said electronic device.

7. An electronic device comprising:
(a) a main unit, adapted to be powered by a power pack; and
(b) a sub-unit, said sub-unit further comprising:
(i) connecting means for interoperably connecting said sub-unit with said main unit, and wherein said connecting means are capable of allowing said sub-unit to be detached from said main unit under the control of a user of said electronic device;
(ii) solar radiation collecting means for collecting light from a light source;
(iii) radiation conversion means for converting said light to first electrical power, said first electrical power for powering said main unit;
(iv) a battery set for providing second electrical power to said main unit; and
(v) electrical power distribution means for distributing said first and said second electrical power.

8. The electronic device of claim 7, wherein said electronic device further comprises a circuit for switching between said first electrical power and said second electrical power.

9. The electronic device of claim 7, wherein said sub-unit is adapted to be removable from said main unit.

10. The electronic device of claim 7, wherein said battery set comprises at least one battery that is rechargeable.

11. The electronic device of claim 10, further comprising:
an electronic power supply and recharging circuit in said sub-unit, and further comprising a solar panel member in series with a diode member; and, wherein said solar panel member and said diode member are in parallel with a rechargeable battery unit, whereby said solar panel member provides a charging energy to said rechargeable battery at least once during or between a use of said electronic device.

12. The electronic device of claim 10, wherein said sub-unit further comprises a circuit for directing said first electrical power to said at least one rechargeable battery for storage.

13. The electronic device of claim 7, wherein said battery set comprises a plurality of batteries and wherein said plurality of batteries further comprises at least one non-rechargeable battery.

14. The electronic device of claim 7, wherein said radiation collecting means and said radiation conversion means are co-located to form a solar cell.

15. The electronic device of claim 14, wherein said solar cell further comprises one or more organic light emitting diodes.

16. The electronic device of claim 7, wherein said battery set comprises at least one rechargeable battery and at least one non-rechargeable battery.

17. The electronic device of claim 8, wherein said battery set comprises at least one rechargeable battery and at least one non-rechargeable battery.

18. The electronic device of claim 17, wherein said sub-unit comprises a removable solar power supply, wherein said non-rechargeable battery is in a circuit in parallel with said rechargeable battery, whereby during an operational use of said electronic device, said switching circuit operatively switches between said non-rechargeable battery and said rechargeable battery to supply operative power to said electronic device.

19. The electronic device of claim 17, wherein said switching circuit includes electronic control means for determining when to switch between said rechargeable battery and said non-rechargeable battery for providing operative power to said electronic device according to a set of electronic control parameters.

20. The electronic device of claim 19, wherein said electronic control parameters include at least one of the following parameters:
(a) a current supply parameter;
(b) a voltage supply parameter;
(c) a power draw parameter from said electronic device;
(d) an estimated charge remaining in said rechargeable battery parameter; and
(e) an estimated charge remaining in said non-rechargeable battery parameter.

21. A power kit for use with a host electronic device, said power kit further comprising:
(a) connecting means for interoperably connecting said power kit with said host electronic device, and wherein said connecting means are capable of allowing said power kit to be detached from said host electronic device by a user of said host electronic device;
(b) solar radiation collecting means for collecting light from a light source;
(c) radiation conversion means for converting said light to first electrical power, said first electrical power for powering said host electronic device;
(d) a battery set for providing second electrical power to said host electronic device; and
(e) electrical power distribution means for distributing said first and said second electrical power.

22. The power kit of claim 21, wherein said power kit is adapted to be removable from said host electronic device.

23. The power kit of claim 21, wherein said battery set comprises at least one battery that is rechargeable.

24. The power kit of claim 21, further comprising an electronic power supply and recharging circuit in said sub-unit, and further comprising a solar panel member in series with a diode member; and, wherein said solar panel member and said diode member are in parallel with a rechargeable battery unit, whereby said solar panel member provides a charging energy to said rechargeable battery at least once during or between a use of said host electronic device.

25. The power kit of claim 21, wherein said power kit further comprises a circuit for directing said first electrical power to said at least one rechargeable battery for storage.

26. The power kit of claim 21, wherein said power unit comprises a plurality of batteries and wherein said plurality of batteries further comprises at least one non-rechargeable battery.

27. The power kit of claim 21, wherein said radiation collecting means and said radiation conversion means are co-located to form a solar cell.

28. The power kit of claim 27, wherein said solar cell further comprises one or more organic light emitting diodes (OLEDs).

29. The power kit of claim 27, wherein said solar cell further comprises one or more inorganic light emitting diodes (ILEDs).

30. The power kit of claim 21, wherein said battery set comprises at least one rechargeable battery and at least one non-rechargeable battery.

31. The power kit of claim 27, wherein said power kit comprises a removable solar cell, and wherein:
(a) said non-rechargeable battery is in a circuit in parallel with said rechargeable battery; and
(b) whereby during an operational use of said host electronic device, a switching circuit operatively switches between said non-rechargeable battery and said rechargeable battery to supply operative power to said host electronic device.

32. The power kit of claim 31, wherein said switching circuit includes electronic control means for determining when to switch between said rechargeable battery and said non-rechargeable battery for providing operative power to said host electronic device according to a set of electronic control parameters.
